(19) United States
(12) Patent Application Publication
(10) Pub. No.: US 2015/0008771 A1
(43) Pub. Date: Jan. 8, 2015

(54) MOTOR HAVING COOLING MEANS

(71) Applicant: KOREA INSTITUTE OF SCIENCE AND TECHNOLOGY, Seoul (KR)

(72) Inventors: Yong Bok LEE, Seoul (KR); Chang Ho KIM, Seoul (KR); Bok Seong CHOE, Gunpo-si (KR)

(21) Appl. No.: 14/104,006

(22) Filed: Dec. 12, 2013

(30) Foreign Application Priority Data
Jul. 5, 2013 (KR) 10-2013-0078837

(51) Int. Cl. H02K 9/06

(52) U.S. Cl. CPC H02K 9/06
USPC 310/62

(57) ABSTRACT

A motor has a stator and a rotor rotating at the center of the stator, and the rotor includes a concave groove formed with a predetermined depth along the circumference of the rotor, and a plurality of blades formed at the concave groove to protrude therein and having a height not greater than the depth of the concave groove, wherein a flow channel is formed between the stator and the rotor along the length direction of the rotor so that air flows therein, and wherein when the rotor rotates, the plurality of blades guides an air flow to the flow channel so that the rotor is cooled.

### CROSS-REFERENCE TO RELATED APPLICATION

This application claims priority to Korean Patent Application No. 10-2013-0078837, filed on Jul. 5, 2013, and all the benefits accruing therefrom under 35 U.S.C. §119, the contents of which in its entirety are herein incorporated by reference.

### BACKGROUND

1. Field

The present disclosure relates to a motor having a cooling means, and more particularly, to a motor having an improved cooling characteristic by using a blade formed at a rotor.

2. Description of the Related Art

In a motor rotating at a high speed, cooling of inner components such as bearings and other parts rotating together with a rotary shaft is very important.

Different from a general motor, an ultrahigh-speed motor for giving a great output generally includes a stator having a coil and a rotor rotating at the center of the stator, and the rotor rotates at a high speed due to interactions between the stator and the rotor using a magnetic force.

The ultrahigh-speed motor may be applied to various applications such as a turbo compressor or a turbo blower.

However, since the ultrahigh-speed rotation of the rotor generates heat in a frame of the motor, which may cause heat and therefore make a device into a dynamically unstable state. Therefore, an additional cooling means is generally provided.

As an additional cooling means, there is proposed a method of mounting a fan and heat dissipation pins at one end of a rotor (a rotary shaft) from the outside of a frame in order to generate an air flow above the frame of the motor.

However, such fan and heat dissipation pins require a relatively large mounting space and therefore it is impossible to design a motor with a small size. In addition, such fan and heat dissipation pins cause a balancing problem, which increases a dynamic unstable property.

Moreover, they are not suitable for a high-speed motor having impellers attached at both ends of a rotor to enhance the efficiency, which is widely used in these days.

Accordingly, there has been proposed a method of coupling an additional fan blade to an upper end of a rotor inside the frame.

However, in this configuration, the length of the rotor (the rotary shaft) inevitably increases, which is disadvantageous when pursues dynamic stabilization or small design.

In addition, for assembling, one end of the rotor should be connected to the frame first, and then the fan blade should be connected to the rotor and another frame should be coupled to the other end of the rotor. In this case, it is difficult to align two frames which support the bearings supporting the rotor.

### SUMMARY

The present disclosure is directed to providing a motor having an improved cooling efficiency, in which a plurality of blades is formed at a rotor not to protrude out of the rotor so that the rotor may contribute to cooling for itself.

In one aspect, there is provided a motor, which includes a stator and a rotor rotating at the center of the stator, wherein the rotor includes: a concave groove formed with a predetermined depth along the circumference of the rotor; and a plurality of blades formed at the concave groove to protrude therein and having a height not greater than the depth of the concave groove, wherein a flow channel is formed between the stator and the rotor along the length direction of the rotor so that air flows therein, and wherein when the rotor rotates, the plurality of blades guides an air flow to the flow channel so that the rotor is cooled.

According to an embodiment, the blade may be integrally formed with the rotor by engraving the surface of the rotor.

In addition, the blade may have a streamlined shape to guide an air flow from an air inlet of the flow channel to an air outlet thereof.

In addition, the motor may further include a frame which supports the stator and the rotor, the rotor may be supported by the frame by means of a bearing, and the air guided by the blade may flow toward the bearing to cool the bearing.

In addition, an air input port for allowing an external air to flow into the frame and an air output port for allowing the air to flow out of the frame may be formed at the frame.

In addition, the external air may be a low-temperature compressed air generated by a compressed air generator.

In addition, the bearing may include two journal bearings which respectively support both ends of the rotor to be rotatable with respect to the frame, and the concave groove may be formed between the two journal bearings.

In addition, the rotor may have two concave grooves respectively formed adjacent to the two journal bearings, and the blade may be formed at each of the two concave grooves.

In addition, the two concave grooves may be respectively formed adjacent to an air inlet and an air outlet of the flow channel at the outside of the flow channel.

In addition, the journal bearing may be an airfoil bearing.

In addition, impellers may be respectively coupled to both ends of the rotor at the outside of the frame.

In addition, the stator may have inclined surfaces near an air inlet and an air outlet of the flow channel in a direction away from the length direction of the rotor.

In addition, the concave groove may be smoothly connected to the surface of the rotor.

In addition, the stator may be made of a coil, the rotor may have a magnet at the center thereof, and the motor may be an ultrahigh-speed motor in which the rotor rotates at an ultrahigh speed by means of interactions with the stator.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a cross sectional view showing an embodiment of the present disclosure.

FIG. 2 is a schematic perspective view showing a rotor having a blade according to an embodiment of the present disclosure.

FIG. 3 is an enlarged view showing the x portion of FIG. 2.

FIG. 4 illustrates that an air flows according to the operation of the motor of FIG. 1.

### DETAILED DESCRIPTION

Hereinafter, an embodiment of the present disclosure will be described with reference to the accompanying drawings. Even though the present disclosure is described with reference to the embodiment depicted in the drawings, this is just an example, and the spirit, essence and operations of the present disclosure are not limited thereto.

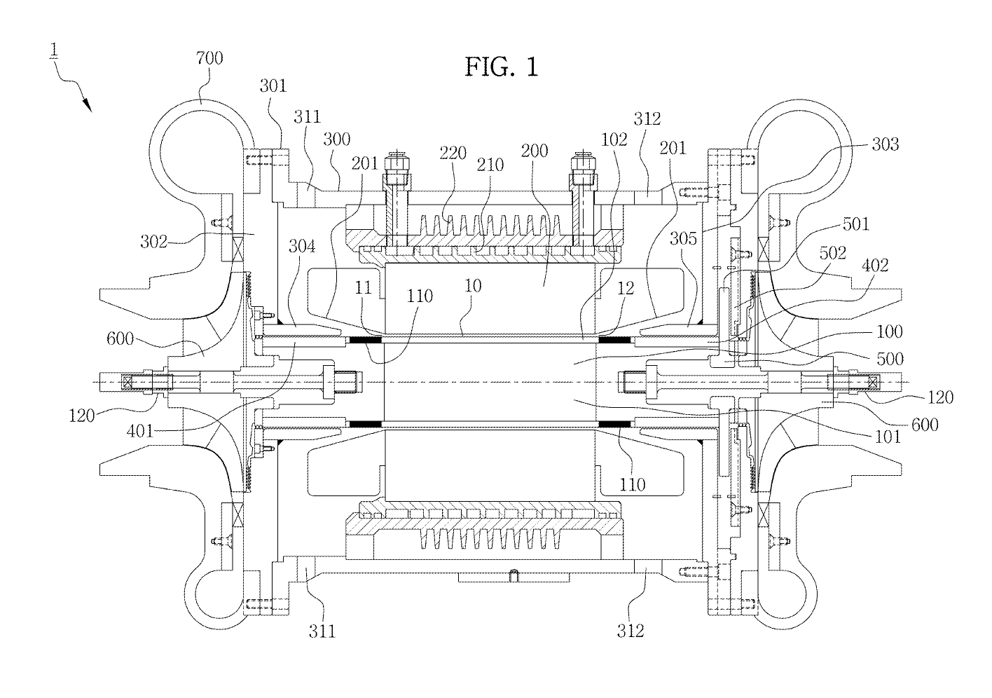

FIG. 1 is a cross sectional view showing a motor 1 according to an embodiment of the present disclosure.

Referring to FIG. 1, the motor 1 of this embodiment includes a stator 200 and a rotor 100 rotating at the center of the stator 200.

The motor 1 of this embodiment is an ultrahigh-speed motor in which the stator 200 and the rotor 100 interact by means of a magnetic force so that the rotor 100 rotates at an ultrahigh speed inside the stator 200.

Though not shown in detail, the stator 200 is made of a coil. The center of the rotor 100 is made of a magnet 101, and a tube 102 surrounds the magnet 101 to configure a surface portion of the rotor 100.

The principle that a stator made of a coil and a rotor made of a magnet interact with each other so that the rotor rotates at a high speed is already well known in the art and will not be described in detail here.

The stator 200 and the rotor 100 are fixed to a frame 300.

The frame 300 includes a horizontal frame 301 surrounding the rotor 100 and the frame 300 and vertical frames 302, 303 coupled to both sides of the horizontal frame 301 to be substantially perpendicular thereto.

The stator 200 is fixed to the horizontal frame 301 through a water jacket 12 and an air tube 13 for cooling the stator 200 and other inner components.

The rotor 100 is inserted into the center of the stator 200, and both ends of the rotor 100 are respectively fixed to the vertical frames 302, 303.

Bearing housings 304, 305 for accommodating journal bearings 401, 402 which support a radial load of the rotor 100 are formed at the horizontal frames 302, 303.

Both ends of the rotor 100 are supported by the journal bearings 401, 402 to be rotatable with respect to the horizontal frames 302, 303. In addition, a thrust bearing 500 composed of a thrust collar 7 and a thrust panel 2 is connected to one end of the rotor 100 to support an axial load of the rotor 100.

The journal bearings 401, 402 and/or the thrust bearing 500 employed in this embodiment may be an air foil bearing using an air as a lubricant instead of oil.

In the motor 1 of this embodiment, rotary shafts 210 respectively extend at both ends of the rotor 100 to protrude out of the horizontal frames 302, 303, and an impeller 600 capable of compressing the air is connected to each of both rotary shafts 210, as a turbo compressor.

A volute 700 may be connected to the outermost side of the motor 1.

As shown in FIG. 1, a flow channel 10 is formed between the rotor 100 and the stator 200 as a small gap along the length direction of the rotor 100, and the flow channel 10 is communicated from an air inlet 11 to an air outlet 12.

An air input port 311 for allowing an external air A to flow to the inside of the frame 300 and an air output port 312 for allowing the air to flow out of the frame 300 are formed through the horizontal frame 300.

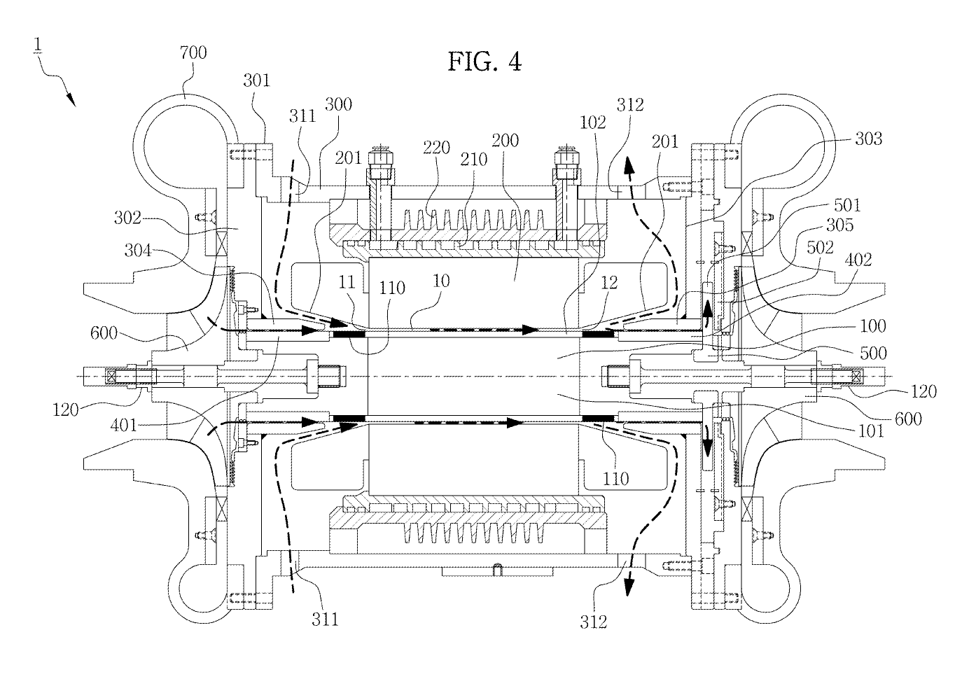

Accordingly, an air flow path of the external air A which enters the air input port 311, flows through the flow channel 10 and discharges from the air output port 312 is established (see FIG. 4).

According to this embodiment, in order to facilitate an air flow through this air flow path, the stator 200 has inclined surfaces 201 inclined in a direction away from the length direction of the rotor 10 near the air inlet 11 and the air outlet 12 of the flow channel 10.

According to this embodiment, the external air A cools the surface of the rotor 100 while flowing along the flow channel 10.

In order to guide an air flow toward the flow channel 10, the rotor 100 of this embodiment has a fan portion 110 integrated with the rotor 100.

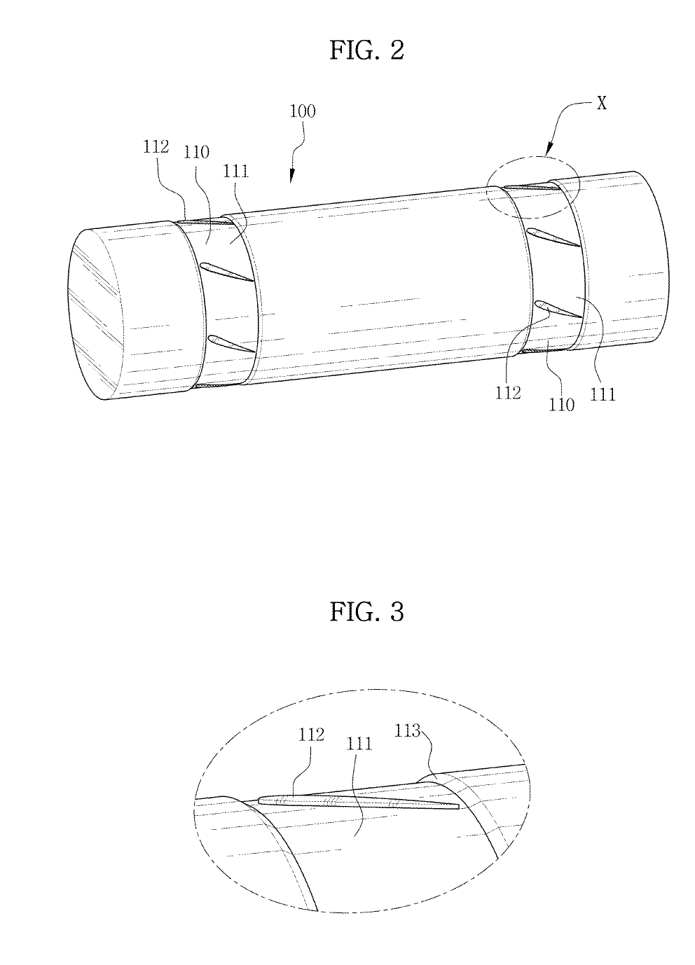

FIGS. 2 and 3 show the fan portion 110 of the rotor 100 in detail.

FIG. 2 shows the entire figure of the rotor 100, and FIG. 3 is an enlarged view showing the x portion of FIG. 2. For convenience, FIG. 2 does not depict journal bearing coupling units formed at both ends of the rotor 100, rotary shafts 120 extending from both ends, and the like.

As shown in FIGS. 2 and 3, the rotor 100 includes a concave groove 111 formed with a predetermined depth along the circumference of the rotor 100, and a plurality of blades 112 formed at the concave groove 111 to protrude.

The blade 112 has a height smaller than or at least equal to the depth of the concave groove 111, so that the blade 112 does not protrude over the surface of the rotor 100.

The plurality of blades 112 is arranged at regular intervals in a radial direction along the circumference of the rotor 100. It should be understood that the number and shape of the blades 112 may be determined according to the rotation speed of the rotor 100 or features of the motor 1.

According to this embodiment, in order to simplify the configuration of the rotor 100 and minimize the deterioration of dynamic features of the rotor 100 caused by an additional component, the blade 112 is formed integrally with the rotor 100 by engraving the surface of the rotor 100.

When engraving the blade 112, the concave groove 111 is formed not to contact the magnet of the rotor 100, preferably at the tube 102. In addition, as best shown in FIG. 3, a joint 113 of the concave groove 111 and the surface of the rotor 100 is formed with a round shape, so that the concave groove 111 is connected smoothly to the surface of the rotor 100.

As described later, if the rotor 100 rotates, the blade 112 guides an air flow toward the flow channel 10 to cool the surface of the rotor 100. In addition, the blade 112 may play a role of a heat dissipation pin capable of dissipating heat generated from the rotor 100, for itself.

According to this embodiment, the blade 112 may have a streamlined shape, more preferably an air foil shape, in order to guide an air flow from the air inlet 11 of the flow channel 10 toward the air outlet 12 thereof.

Referring to FIG. 2, two fan portions 110 are symmetrically formed near both ends of the rotor 100.

Referring to FIG. 1 again, the concave grooves 111 of two fan portions 110 are respectively formed adjacent to the air inlet 11 and the air outlet 12 of the flow channel 10 at the outside of the flow channel 10. In addition, two concave grooves 111 are formed between two journal bearings 401, 402.

If the fan portion 110 is formed as above, the cooling efficiency toward the rotor 100 and the bearings 401, 402, 500 is maximized, as proved through experiments.

FIG. 4 shows an air flow at the motor 1 of this embodiment.

As shown in FIG. 4, if the rotor 100 rotates, the external air A flowing in through the air input port 311 is guided by an action of the blade 112 to flow through the air inlet 11 to the flow channel 10.

The external air A is generally an air in a natural state but may also be a low-temperature compressed air generated by a compressed air generator (not shown), depending on a caloric value of the motor 1 or features of a system.

The external air A entering the flow channel 10 flows through the flow channel 10 and cools the surface of the rotor 100.

The external air A passing through the flow channel 10 is discharged through the air outlet 12 to the air output port 312.

Meanwhile, as shown in FIG. 1, the external air is guided by the blade 112 located near the air inlet 11 to flow into a gap between the inner and outer rims of the journal bearing 401 and/or between the journal bearing 401 and the housing 304. The journal bearing 401 is cooled by means of this air flow.

In addition, the external air may be guided by the blade 112 located near the air inlet 12 to flow into a gap between the inner and outer rims of the journal bearing 402 and/or between the journal bearing 402 and the housing 305. Further, the external air A passes through the thrust bearing 500. The journal bearing 402 and the thrust bearing 500 may be additionally cooled by means of this air flow.

According to the motor 1 configured as above, since the rotor plays a role of a cooling fan for itself, the system may have a simpler configuration and a reduced processing cost, in comparison to cases in which an additional axial fan is mounted to a rotor (or a rotary shaft).

In addition, due to the guiding operation of the blade, it is possible to cool not only the surface of the rotor but also the bearing supporting the rotor, which may maximize the cooling efficiency.

In particular, in the case the bearings supporting the rotor are air foil bearings, since at an initial operation before being supported inside the air foil bearings, a frictional heat caused by a friction of the bearing surfaces and a shear flow of air generated at an air film is effectively cooled, the dynamic characteristics of the air foil bearings may be stabilized.

In addition, according to this embodiment, since the blade 112 does not protrude over the surface of the rotor, the gap between the rotor 100 and the stator 200 (namely, the width of the flow channel 10) may be minimized, which allows reducing the size of the motor 1.

Further, if the motor 1 of this embodiment is used, all problems of the existing art may be effectively improved.

In detail, different from a general motor in which an axial fan is separately mounted to one side of a rotor in or out of a housing and the mounted fan has a greater diameter than that of the rotor, in this embodiment, the blade does not protrude over the surface of the rotor, thereby effectively keeping the balancing of the motor 1. In addition, since the rotation of the rotor is not disturbed by a fan with a large diameter, the motor of this embodiment may be suitably used as an ultrahigh-speed motor in which the rotor rotates at an ultrahigh speed.

According to this embodiment, it is possible to adopt a dual-impeller configuration (in other words, in which two impellers are respectively connected to both ends of the rotor), which is impossible in an existing technique in which a separate axial fan is mounted to one side of the rotor out of the housing.

In addition, according to this embodiment, in comparison to an existing technique in which a separate axial fan is mounted to one side of the rotor at the inside of the housing, an assembling characteristic and an housing (and the journal bearing) aligning characteristic are improved.

This will be described in more detail with reference to FIG. 1. In the existing technique, the rotor 100 is connected to the second vertical housing 303, an axial fan is mounted to a side opposite to the second vertical housing 303, and then the first vertical housing 302 should be connected to the rotor 100 again. Therefore, a lot of endeavors is required to align two vertical housings 302, 303 and the journal bearings 401, 402 connected thereto in advance.

However, according to this embodiment, since the blade does not protrude over the surface of the rotor, after the first vertical housing 302 and the second vertical housing 303 are connected to the horizontal housing 301 and the journal bearings 401, 402 connected thereto are aligned, the rotor 100 may be inserted into the first vertical housing 302 and the second vertical housing 303.

Therefore, the aligning work may be performed rapidly and accurately without any follow-up aligning procedure.

In addition, since it is not needed to install a separate axial fan to the rotor 100, the rotor 100 may be formed with a short length, which may improve the dynamic characteristics of the rotor 100.

What is claimed is:

1. A motor, which includes a stator and a rotor rotating at the center of the stator,
wherein the rotor includes:
a concave groove formed with a predetermined depth along the circumference of the rotor; and
a plurality of blades formed at the concave groove to protrude therein and having a height not greater than the depth of the concave groove,
wherein a flow channel is formed between the stator and the rotor along the length direction of the rotor so that air flows therein, and
wherein when the rotor rotates, the plurality of blades guides an air flow to the flow channel so that the rotor is cooled.

2. The motor according to claim 1,
wherein the blade is integrally formed with the rotor by engraving the surface of the rotor.

3. The motor according to claim 1,
wherein the blade has a streamlined shape to guide an air flow from an air inlet of the flow channel to an air outlet thereof.

4. The motor according to claim 1, further comprising a frame which supports the stator and the rotor,
wherein the rotor is supported by the frame by means of a bearing, and
wherein the air guided by the blade flows toward the bearing to cool the bearing.

5. The motor according to claim 4,
wherein an air input port for allowing an external air to flow into the frame and an air output port for allowing the air to flow out of the frame are formed at the frame.

6. The motor according to claim 5,
wherein the external air is a low-temperature compressed air generated by a compressed air generator.

7. The motor according to claim 4,
wherein the bearing includes two journal bearings which respectively support both ends of the rotor to be rotatable with respect to the frame, and
wherein the concave groove is formed between the two journal bearings.

8. The motor according to claim 7,
wherein the rotor has two concave grooves respectively formed adjacent to the two journal bearings, and
wherein the blade is formed at each of the two concave grooves.

9. The motor according to claim 8,
wherein the two concave grooves are respectively formed adjacent to an air inlet and an air outlet of the flow channel at the outside of the flow channel.

10. The motor according to claim 7,
wherein the journal bearing is an air foil bearing.

11. The motor according to claim 1,
wherein impellers are respectively coupled to both ends of the rotor at the outside of the frame.

12. The motor according to claim 1,
wherein the stator has inclined surfaces near an air inlet and an air outlet of the flow channel in a direction away from the length direction of the rotor.

13. The motor according to claim 1,
wherein the concave groove is smoothly connected to the surface of the rotor.

14. The motor according to claim 1,
wherein the stator is made of a coil,
wherein the rotor has a magnet at the center thereof, and
wherein the motor is an ultrahigh-speed motor in which the rotor rotates at an ultrahigh speed by means of interactions with the stator.
